(19) United States
(12) Patent Application Publication
(10) Pub. No.: US 2025/0334863 A1
(43) Pub. Date: Oct. 30, 2025

(54) MOBILE PHOTOGRAPH APPARATUS AND SYSTEM

(71) Applicant: Lumatic Imagery, LLC, Indianapolis, IN (US)

(72) Inventor: Tyler Hromadka, Indianapolis, IN (US)

(73) Assignee: Lumatic Imagery, LLC, Indianapolis, IN (US)

(21) Appl. No.: 19/037,530

(22) Filed: Jan. 27, 2025

Related U.S. Application Data
(60) Provisional application No. 63/625,627, filed on Jan. 26, 2024.

(51) Int. Cl. G03B 17/56; A45C 11/38; G03B 15/03; H04N 23/51; H04N 23/55

(52) U.S. Cl. CPC G03B 17/561; G03B 15/03; H04N 23/51; H04N 23/55; A45C 11/38; G03B 2215/0567

(57) ABSTRACT

An apparatus, method, and system are provided for using a portable camera kiosk that facilitates setup, lighting, and focus for subject to be photographed. Apparatus includes chassis or kiosk which houses a camera and a screen and may have a curved or concave shape for reflecting light. The apparatus may have a light source which angles diffused or reflected light off of the curved portion of the kiosk toward the subject. The tip of the curved portion may extend closer to the subject than the lens or the light source. The system includes setup methods for shipping and configuration. The method includes a novel casing for inserting shipping information in a viewing panel from one patron to the next without requiring retrieval of the camera kiosk.

### CROSS REFERENCE TO RELATED APPLICATIONS

This application claims the benefit of U.S. Provisional Application No. 63/625,627 filed Jan. 26, 2024, which is hereby incorporated by reference in its entirety.

### BACKGROUND

Cameras, and devices containing cameras, are often deployed for use in locations necessitating different configurations and features. For example, devices which house cameras are often needed in locations for events which people wish to commemorate or add to the experience of festivities and occasions. An example of this includes photo booths and camera kiosks. Additionally, many organizations routinely need to capture photographs of the people who participate, including via headshots. Often, difficult or cumbersome setup, calibration, and/or configuration is required. Typically, the presence of an operator, facilitator, or person to otherwise set up or manage the operation of the device is needed. Additionally, transport of devices to and from the event is a difficult task.

Thus, there is a need for improvement in this field.

### SUMMARY

Camera kiosks, photo booths, and other devices containing cameras or systems using cameras, are commonly used in social and private functions. A device and a system have been developed which, for example, assist users in receiving, configuring, and/or programming a camera-containing device suited for the situation at hand. Such devices may include easily configurable and transportable aspects. Such a device may also be designed to optimize the photographic quality and may be calibrated to facilitate optimum photographic effect as called for by the context including, for example, lighting, background, and other contexts.

Often times, the method of deploying such a device is cumbersome, expensive, and/or requires hands-on personnel present at the site. This disclosure also includes a method of deploying, securing, and/or setting up the device for ease of interaction with the end-user as well as a novel method of facilitating use and transfer from one user to the next without needing the owner of the device to re-possess the device between each use. The device may come with a ready-made system to facilitate ease of setup. The system may include software packages as well as pre-programmed aspects. The software system disclosed herein and preprogrammed aspects of the software disclosed herein may be activated with a QR code or other two-dimensional recognition codes, such as barcodes. Additionally, the system may take input from the environment in which it is being used so as to make adjustments which improve the quality of the photograph, including focus, lighting, contrast, and other such photographic variables which will be appreciated by persons of ordinary skill in the art. In some aspects, showing a QR code to the kiosk 100 (such as to the lens) causes the kiosk to read the QR code and may be used to implement certain settings or configurations of the kiosk 100.

Also disclosed is a system for setting up, onboarding, capturing, and editing photographs based upon the desires of the end user. Systems disclosed herein may be activated via a QR or a SHOOT code which communicates to the device. Devices and systems disclosed herein are also capable of activation by recognition of a three-dimensional object such as a facial recognition, as well as recognizing glasses, clothing, hats, and other items. In some instances, the device is prompted to provide particular outputs on the user interface upon recognition of a three-dimensional object such as a person's face. The software can further remove glassware glare.

Devices disclosed herein may include a camera kiosk configured for multiple purposes and settings, including headshots, as a photo booth, at events, and includes multiple components to facilitate a self-actuating photograph or video system.

Systems disclosed herein and techniques as described and illustrated herein concern a number of unique and inventive aspects. Some, but by no means all, of these unique aspects are summarized below.

### BRIEF DESCRIPTION OF THE DRAWINGS

FIG. 1 illustrates a perspective view of a camera kiosk according to an embodiment.

FIG. 2 illustrates a perspective view of a camera kiosk in use while in a horizontal orientation with a subject standing in front of the camera kiosk.

FIG. 3 illustrates a side view of a camera kiosk according to an embodiment.

FIG. 4 illustrates a front view of a camera kiosk according to an embodiment in a vertical orientation.

FIG. 5 illustrates a front view of a camera kiosk according to an embodiment in a horizontal orientation.

FIG. 6 illustrates a top view of a camera kiosk according to an embodiment.

FIG. 7 illustrates a side view of a camera kiosk according to an embodiment.

FIG. 8 illustrates a bottom view of a camera kiosk according to an embodiment.

FIG. 9 illustrates a back view of a camera kiosk according to an embodiment.

FIG. 10 illustrates a perspective view of a camera kiosk according to an embodiment.

FIG. 11 illustrates a perspective view of a camera kiosk according to an embodiment.

FIG. 12 illustrates an exploded view of a camera kiosk according to an embodiment.

FIG. 13 illustrates an exploded view of a camera kiosk according to an embodiment.

FIG. 14 illustrates a perspective view of a case according to an embodiment.

FIG. 15 illustrates a perspective view of a case according to an embodiment.

FIG. 16 illustrates a perspective view of a case according to an embodiment.

FIG. 17 illustrates a zoomed-in view of a case according to an embodiment.

FIG. 18 illustrates a zoomed-in view of a case according to an embodiment.

FIG. 19 illustrates a perspective view of the inside of a camera kiosk according to an embodiment.

FIG. 20 illustrates a perspective view of the inside of a camera kiosk according to an embodiment.

FIG. 21 illustrates a diagram of parts of a camera kiosk to be mailed to a patron according to an embodiment.

FIG. 22 illustrates a zoomed-in perspective view of aspects of a camera kiosk according to an embodiment.

FIG. 23 illustrates a zoomed-in perspective view of aspects of a camera kiosk according to an embodiment.

FIG. 24 illustrates a front view of a camera kiosk according to an embodiment in a vertical orientation.

FIG. 25 shows a diagram of light cast and reflected by a camera kiosk according to an embodiment.

FIG. 26 shows a zoom-in of a diagram of light cast and reflected by a camera kiosk according to an embodiment.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

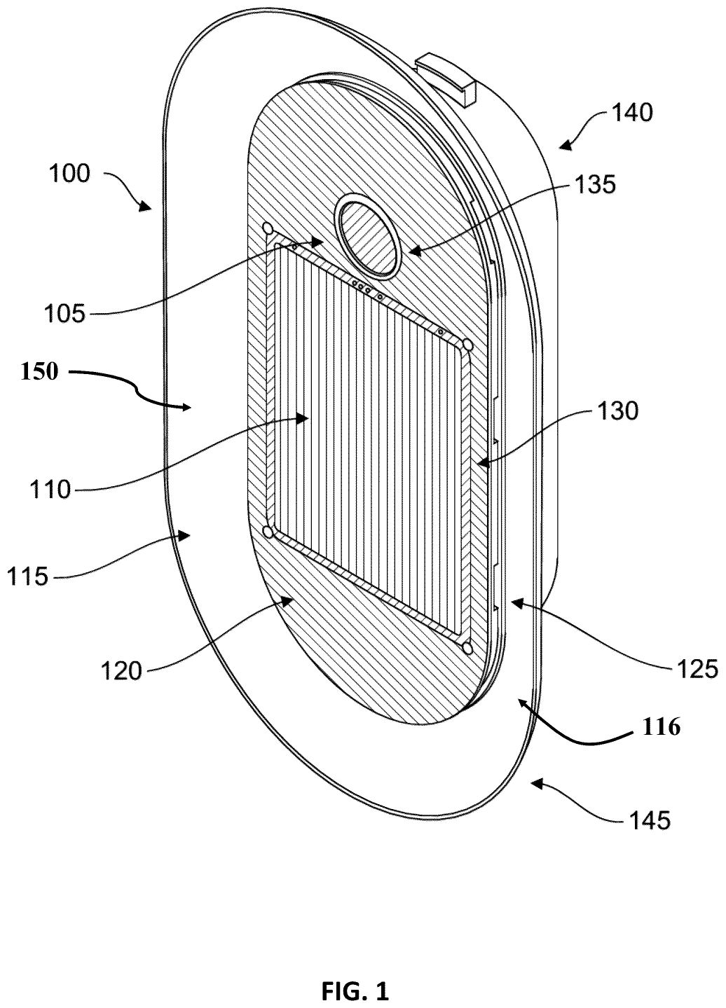

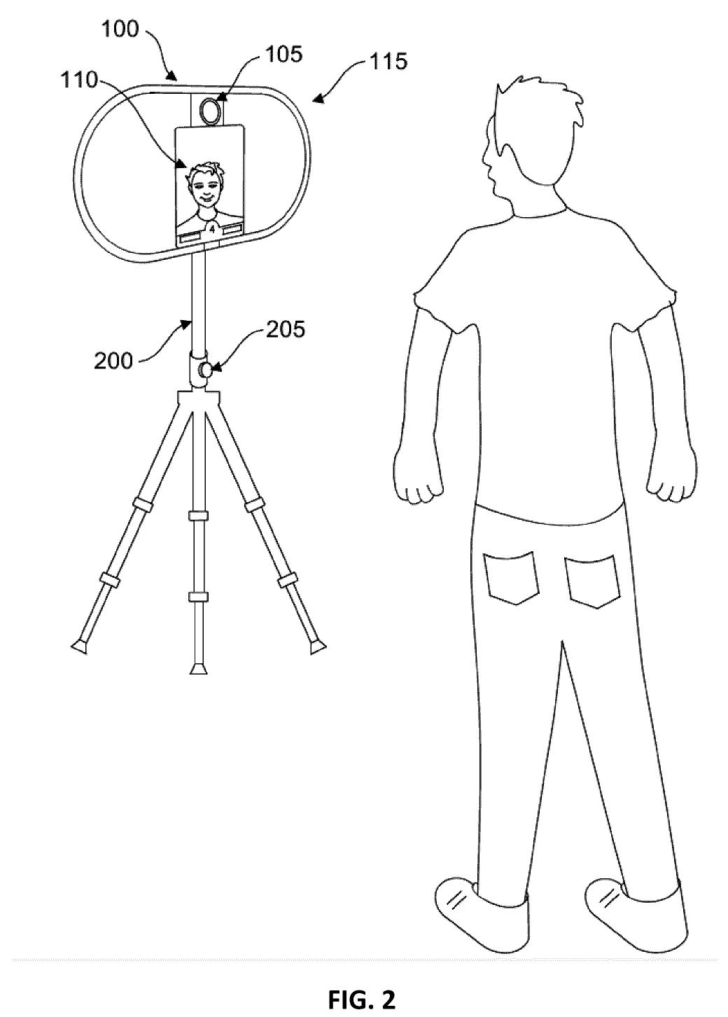

The reference numerals in the following description have been organized to aid the reader in quickly identifying the drawings where various components are first shown or discussed. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation

FIG. 1 shows a perspective view of an embodiment of a camera kiosk 100. The kiosk 100 may have a chassis which houses or holds together multiple aspects of the system or apparatus. In this particular embodiment, the kiosk 100 is oval in shape and is oriented to stand vertically. Orienting the kiosk vertically allows a shorter stand to be employed to achieve optimum camera height for an expected height range of adults. In other embodiments, the height of the kiosk 100 is arranged for children or persons of below-average height. In other embodiments, the kiosk 100 is arranged to capture photographs of individuals of above-average height.

The kiosk 100 depicted in the embodiment of FIG. 1 also shows a camera lens 105. In this embodiment, camera height is directed such that a camera lens 105 may be outfitted with different features. Camera lens 105 optionally but preferably has a focus range for photographing persons ranging from 7′5″ to 3′0″. More preferably, the camera lens 105 has a focus range for photographing persons ranging from 5′0″ to 6′5″. In some embodiments, the lens does not have a fixed focus length. In such embodiments, the lens has a focal length of 14-24 mm, 14-28 mm, 14-30mm, 16-50 mm, 17-28 mm, 24-70 mm, 28-75 mm, or 70-200 mm. In some embodiments, the lens has a fixed focal length. In certain aspects, the lens has a focal length of 12 mm, 24 mm, 35mm, 40 mm, 50 mm, 80 mm, 85 mm, or 120 mm. The camera lens 105 optionally but preferably has a 35 mm lens to provide a relatively wide angle of view with minimum distortion. The apparatus and system may include a camera lens 105 and camera which is programmed to accommodate different lighting, focusing, exposure, or other aspects of the photography or video. The combination of the height of the kiosk 100 and the focal length of the lens may be used to assist in capturing a range of heights and distances for subjects. In this particular embodiment, the camera lens is attached to a stand-alone camera which has been mounted within the kiosk 100. In this example, the camera lens 105 is part of a sophisticated, high-powered camera such as those manufactured by Canon. In some embodiments, the camera is a mirrorless camera. In other embodiments, the camera is a DSLR camera. In some preferred embodiments, the use of a high-powered camera and/or camera lens allows for rapid shutter and can facilitate at least 50 photographs per minute or more. In some embodiments, the camera lens 105 is capable of video as well as photographs.

The kiosk 100 of FIG. 1 also depicts a screen 110 which is capable of displaying a graphical user interface. In certain embodiments, the screen 110 is part of the same device that contains the camera lens 105. The lens 105 may be housed within a device or may be functionally integrated with the screen 110. For example, the lens 105 may be within a Canon camera which can be functionally integrated with a screen device such as an iPad or other touchscreen device which optionally but preferably displays an interface and/or displays results of the photograph. The screen 110 may be configured to facilitate user experience flow, a graphical user interface, and/or to direct the user's experience for the photography session. In some embodiments, the user will be shown the photos they have taken so that a photograph may be selected for further use.

In other embodiments, the lens 105 may be housed within the same device as the screen 110. In still further embodiments, the kiosk 100 is a singular unit which comprises the camera lens 105 and the screen 110. For example, in some embodiments, the camera kiosk 100 implements the screen and camera from an iPhone or an iPad.

In the embodiment depicted in FIG. 1, the kiosk 100 optionally but preferably is configured to include a housing in the shape of a tub 115 and to include a faceplate 120. The tub 115 optionally but preferably has a distal portion 116. The distal portion 116 of the tub 115 is in the form of an oval or round or ring shape in the embodiment shown in FIG. 1. The tub 115 shape may be constructed of a lightweight, durable material which facilitates use and handling. In the embodiment shown in FIG. 1, the tub is constructed of a primarily smooth material which is easy to grip such as a composite plastic, molded plastic, injection molded plastic, or polymer. Optionally but preferably, the kiosk 100 is lightweight enough to be handled by a singular person. Optionally but preferably, the kiosk 100 disclosed herein is structurally rigid or thick to prevent damage during use or shipping. Optionally but preferably, the tub 115 has a material finish which facilitates gripping of the tub 115 so as to reduce the likelihood that the tub 115 will be dropped when handled.

The tub 115 optionally but preferably includes a curve, parabola, or sinusoidal shape as the tub 115 extends outward from face plate 120 and extends away from the lens 105 to the distal portion 116. The edges of tub 115 may be given a concave shape relative to the front-center of the kiosk 100 such that the tub 115 can help to facilitate proper light reflection and may diffuse reflected light.

Additionally, the faceplate 120 may be more light-absorbent than the outer portion, or the distal portion 116, of the tub 115. The faceplate 120 being more light-absorbent than the distal portion 116 or outer portion of the tub 115 is optionally but preferably achieved by use of a more light-absorbent material or darker coloring on the faceplate 120. Conversely, the distal portion 116 of tub 115 is optionally but preferably constructed of a reflective material and/or is relatively lighter or brighter in color. The tub 115 may have a material finish with texture or shine to facilitate light reflection.

The faceplate 120 is optionally but preferably black or relatively darker than the outer portion of the tub 115. Configuring the kiosk 100 such that the faceplate 120 is more light absorbent relevant to the outer portion of the tub 115 may assist to reflect light at the outer edges of kiosk 100 and absorb light toward the inner portion of the kiosk 100 so as to promote proper light settings for the context of the photograph or image capture. In this particular embodiment, the shape of the edges of tub 115 are curved such as to direct reflected light to illuminate a space of 0.1 to 12 feet. In other preferred embodiments, the edges of tub 115 are curved such as to direct reflected light to illuminate a space of 0.5 to 9 feet. In further preferred embodiments, the edges of tub 115 are curved such as to direct reflected light to illuminate a space of 1 to 6 feet.

The faceplate 120 may further have a logo or other information inscribed. The faceplate 120 may further comprise channels to facilitate cables to pass through and/or to facilitate airflow passthrough. The faceplate 120 may additionally have openings for connection to the remainder of the kiosk 100. The faceplate may be recessed interior from the edges of the tub 115 in order to facilitate protection of the electronics or relatively more valuable aspects of the kiosk 100.

FIG. 1 depicts a kiosk 100 which has a housing in the shape of an oval tub 115 which is optionally but preferably elongated. The oval tub 115 may assist in causing reflected light to illuminate a vertical subject evenly. For instance, the oval tub 115 may be placed on a stand such that the elongation extends in a vertical direction when set up and may be placed in front of a subject who is in the upright position, either sitting or standing, and is therefore more tall than wide. Conversely, in other embodiments, the tub 115 is an oval shape which is horizontally elongated which may assist in causing reflected light to illuminate a horizontal landscape evenly.

In the embodiment depicted in FIG. 1, the front edge of the surface of tub 115 is closer in proximity to the user than the lens 105 such that the light amongst the user and the lens 105 is affected to provide proper optics.

In some embodiments, tub 115 may be structurally rigid or have a thickness so as to protect the integrity of the innards of the kiosk 100 during use, shipping, or as a result of receiving a force. The tub 115 also may be texturized with a relatively reflective material as compared to the faceplate 120. The tub 115 may be constructed of a material that reflects light without color cast. In some embodiments, the tub 115 is white or nearly white. In FIG. 1, the faceplate 120 has a material finish such that it shines to align in appearance with screen 110. In such embodiments, the congruent appearance may provide a uniform aesthetic. In the embodiment depicted in FIG. 1, the shape of faceplate 120 is of an oval which is congruent with the shape of tub 115 so as to facilitate housing and even lighting.

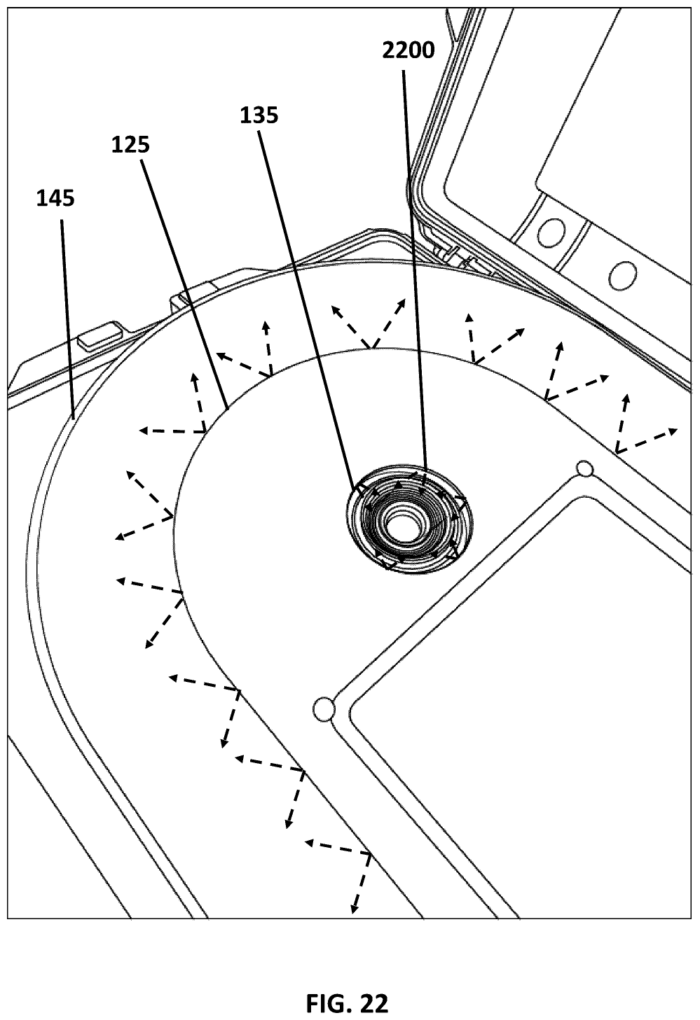

Further discussing the embodiment shown in FIG. 1, the faceplate 120 may have a lightstrip 125 on the posterior edge of faceplate 120 so as to provide light which reflects upon the curve of tub 115. Such a curve of tub 115 may, in some instances, reflect light toward the direction of the subject being photographed or of whom video is being taken. In some embodiments, the tub 115 is curved such that light is deflected at an angular direction relative to the user being photographed or videotaped, such as angles between 0 degrees and 90 degrees relative to the user or at angles between 0 degrees and 180 degrees relative to the user. In FIG. 1, the lightstrip 125 has settings for yellow light and/or white light. In other embodiments, the lightstrip 125 is capable of emitting lights of other colors along the visible light spectrum such as green, yellow, purple, blue, et cetera. Thus, the kiosk 100 is, in some embodiments, capable of optimizing the light necessary for the context of the setting. For instance, if the subject is in a room with primarily yellow light, the kiosk 100 might use yellow light. On the other hand, in some instances such as when the kiosk 100 is being used in an atrium or more spacious room, yellow light may not be as optimum and the lightstrip 125 will emit white light. In FIG. 1, the faceplate 120 has a thickness wide enough to house lightstrip 125. In other embodiments, the faceplate 120 has an outer groove which facilitates housing of lightstrip 125. The screen 110, the camera lens 105, the lens orifice 135, or another aspect of the kiosk 100 may detect the lighting of the area in which it is being used and will automatically adjust the settings of the camera, the lens, and/or the lighting to improve the photograph or video quality. Orienting the light source toward the lip 145 and/or the curve of the tub 115 coupled with the optionally but preferably reflective nature of the distal portion 116 causes reflective light to be shed or reflected in the direction of the subject being photographed or videotaped. The light cast by the lightstrip 125 may additionally cast light radially perpendicular to the direction the lens 105 is facing across the outer array of arrows shown in FIG. 22 towards the lip 145.

The kiosk 100 optionally but preferably has a lip 145 which is located on the radially distal portion of the tub 115 of the kiosk 100 relative to the lightstrip 125. In some embodiments, the lip 145 is positioned such as to catch, direct, or reflect light emitted from the lightstrip 125 to achieve the desired lighting effects. For instance, the lip 145 may be positioned within or adjacent to a curve of the tub 115 such that the light deflects and/or is reflected perpendicular relative to the face of the camera lens 105. The kiosk 100 optionally but preferably has a curve 150, which extends away from the lens and toward the subject to be photographed, creating a concave configuration. Orienting a light source toward the curve 150 optionally but preferably causes the tub 115 to diffuse reflected light. The curve 150 of tub 115 optionally but preferably causes reflected light to be cast, which may enhance the lighting of a photo shoot or video.

Optionally but preferably, the lip 145 is located closer to the subject of the photograph than the lens 105. The lightstrip or another light source optionally but preferably emits light radially, relatively perpendicular to the angle of the lens which is reflected by the curve of the tub 115 and the lip 145 to illuminate the subject area being photographed. In some embodiments, the center of the camera lens is 7.75 inches from the lip 145. In other embodiments, the camera lens is 5 inches from the lip 145. In other embodiments, the camera lens is 3 inches from the lip 145. In other embodiments, the camera lens is 8 inches from the lip 145. In other embodiments, the camera lens is 9 inches from the lip 145. In other embodiments, the camera lens is 10 inches from the lip 145. In some embodiments, the lip 145 extends exactly or about ⅝ of an inch from the camera lens in the direction the camera lens is pointing and toward the subject. In some embodiments, the lip 145 extends exactly or about ⅜ of an inch from the camera lens in the direction the camera lens is pointing and toward the subject. In some embodiments, the lip 145 extends exactly or about ⅛ of an inch from the camera lens in the direction the camera lens is pointing and toward the subject. In some embodiments, the lip 145 extends exactly or about 6/8 of an inch from the camera lens in the direction the camera lens is pointing and toward the subject. In some embodiments, the lip 145 extends exactly or about ⅞ of an inch from the camera lens in the direction the camera lens is pointing and toward the subject. In some embodiments, the lip 145 extends exactly or about 1 inch from the camera lens in the direction the camera lens is pointing and toward the subject. In some embodiments, the lip 145 extends exactly or about 2 inches from the camera lens in the direction the camera lens is pointing and toward the subject. In some embodiments, the lip 145 extends exactly or about 3 inches from the camera lens in the direction the camera lens is pointing and toward the subject. In some embodiments, the lip 145 extends exactly or about 4 inches from the camera lens in the direction the camera lens is pointing and toward the subject. In some embodiments, the lip 145 extends exactly or about 5 inches from the camera lens in the direction the camera lens is pointing and toward the subject.

In some embodiments, the lightstrip 125 may include a series of LEDs or other such bulbs. In certain embodiments, each LED of the lightstrip 125 is individually programmable and the array of lights are capable of being arranged in multiple configurations. For example, the lights on a certain portion of the lightstrip 125 may be set to a particular light setting or color while a separate portion of the lightstrip 125 is set to a different light setting or color. The lightstrip 125 may be configured to communicate information or display separate settings throughout the user experience (UX) flow of the program. As an example, the lightstrip 125 may display blue light while the program is waiting or red when the program is malfunctioning or an error has occurred. In some embodiments, the lightstrip or other light source may be a light emitting diode (LED) which can be modified. In some embodiments, the color temperature can be modified between 1,000 K and 10,000 K. In some aspects, the screen has an LED screen, or an OLED screen, or a liquid crystal display (LCD). Additionally, the kiosk 100 is optionally but preferably programmed to detect light settings in the room in which it is being used and adjusting based on such inputs. The lightstrip 125 may also be programmed to achieve specific photographic results.

The faceplate of the kiosk 100 depicted in FIG. 1 may also have a screen orifice 130 which houses a screen 110. The faceplate 120 may also have holes for screws or fasteners which hold the screen 110 in place. Additionally, the embodiment in FIG. 1 has a lens orifice 135 which may house the lens 105. In some embodiments, the surface of faceplate 120 sits flush with the surface of the lens 105 at the lens orifice 135 such that the frontal plane of that area of the kiosk 100 appears relatively flat. In other embodiments, the lens 105 has a space at the lens orifice 135 such that the lens 105 may make micro-adjustments by zooming forward or backward within the kiosk 100. In other embodiments, the lens orifice 135 may be illuminated such that the user's eye is drawn toward the camera or the lens 105. Such a configuration in which lens orifice 135 is illuminated may be particularly useful to individuals which cannot read, hear, or are who non-verbal, such as small children because the light emitted from lens orifice 135 can direct the user's eye as to where to look or focus their gaze during the photo or video session. In some embodiments, the surface of the faceplate 120 sits flush with the face of the screen 110.

In some embodiments, the tub 115 has a material finish that has a shine so as to facilitate light reflection. In some embodiments, the tub 115 is configured to have a material that has a texture to facilitate friction for increased grip when handling. In some embodiments, the front surface or the surface of tub 115 which optionally but preferably faces the user while in use is made of a bright, smooth material, which is reflective or has a shine while the back surface of the tub 115 which is not directly facing the user while the device is in use may be configured with a material that has a texture which facilitates grip. In some embodiments, the shape of the tub 115 has an edge or flange to facilitate grip from all 360 degrees of access.

Other embodiments of this disclosure may include an easily assembled or ready-to-use device which may house a camera lens 105. In some embodiments, a housing can facilitate the integration of a third-party device such as an iPad or other surface tablet. The device may be equipped with a camera and a screen to facilitate graphical user interface.

The embodiment shown in FIG. 1 may also have a housing bay 140 which may be used to hold or contain the hardware necessary for use of the kiosk 100. The housing bay 140 may be configured to hold and arrange equipment including, but not limited to a camera, a screen, a fan, a circuit power, a power source, a GPS device such, for example, an Airtag.

FIG. 2 shows a digital image of one embodiment of a device in use by a subject, including the camera kiosk and a stand 200 for holding and displaying the kiosk 100. In some embodiments, the totality of the pieces which are necessary are the kiosk 100 and the stand 200. In some embodiments, the stand 200 is configured in one piece. In some embodiments, the stand 200 is foldable upon itself such as to facilitate packing. In other exemplary embodiments, the stand 200 is configured to expand or contract within itself such as by utilizing a sliding feature in which a portion of the stand 200 may slide into a second portion to reduce the longitudinal length of the stand 200 or expand the longitudinal length of the stand 200. In the embodiment depicted in FIG. 2, stand 200 may have an end which is tapered so as to assist the user in placing the kiosk 100 on the stand 200. The tapered end of stand 200 may be configured to allow the top end of stand 200 to more easily slide into kiosk 100 because the relatively narrow tip of stand 200 will have a diameter less than the diameter of the opening on the kiosk 100. In some embodiments, the stand 200 is tapered at the top or striated at the top so as to prevent suction which hinders removal of the kiosk 100 during disassembly. In some embodiments, the stand 200 is manufactured at a height tall enough to enable on/off mounting without any additional securing. The stand 200 depicted in FIG. 2 includes a clamp 205 for tightening or securing the stand 200 or the constituent parts of the stand 200 in certain embodiments. In some embodiments, the stand 200 has an internal or external pin for reinforcing strength and stability of the stand 200 and the connection between stand 200 and kiosk 100. In some embodiments, the kiosk 100 and/or opening for stand 200 complies with Video Electronics Standards Association (VESA) standards, including VESA MIS-D, VESA MIS-E or VESA MIS-F standards.

Referring further to FIG. 2 and stand 200, in some embodiments, the tub 115 simply sits atop stand 200 as opposed to being attached via screws, snaps, or threads. In such embodiments, the stand 200 has ridged edges and tub 115 has ridged edges in the attachment orifice. The ridged edges optionally but preferably prevent rotation of the tub 115 when tub 115 is atop the stand 200. In some embodiments, the stand 200 and attachment orifice of tub 115 have a pentagonal shape with ridges to assist in preventing rotation of the tub 115 while the tub sits atop the stand 200. In other embodiments, the kiosk 100 has screws or a screw plate for mounting to a stand or a wall. In other embodiments, the shape of the attachment orifice is square, triangular, hexagonal, et cetera.

In many embodiments, the tub 115 will be used in a vertical configuration with the camera lens optionally but preferably above the screen orifice 110. Configuring the tub 115 vertically allows for a shorter stand to be used, which safeguards against tipping over and increased durability and reinforcement of the stand because the stand will not need to be completely vertically extended. Using a shorter stand 200 also allows for greater ease of shipping and handling by not requiring a larger case. Further, when the kiosk 100 is in vertical orientation, kiosk 100 will more likely be the proper height for the subject of the photograph.

In certain embodiments, this disclosure may include a system or method of delivering a portable camera kiosk. This disclosure includes business methods pertaining to packaging a smart camera kiosk 100, packaging the camera kiosk in a specialized case, optionally but preferably providing a setup which optionally but preferably does not require the use of tools, providing instructions discussed further herein, a postal window, and providing for the camera to be shipped to from customer to customer without necessitating retrieval. In such embodiments, the method may include two or more parts which are assembled. In other embodiments, the devices includes three parts by virtue of the kiosk 100 and a stand 200 which has two parts. In other configurations, the apparatus comprises a kiosk 100 and two or more parts which may be assembled into a stand.

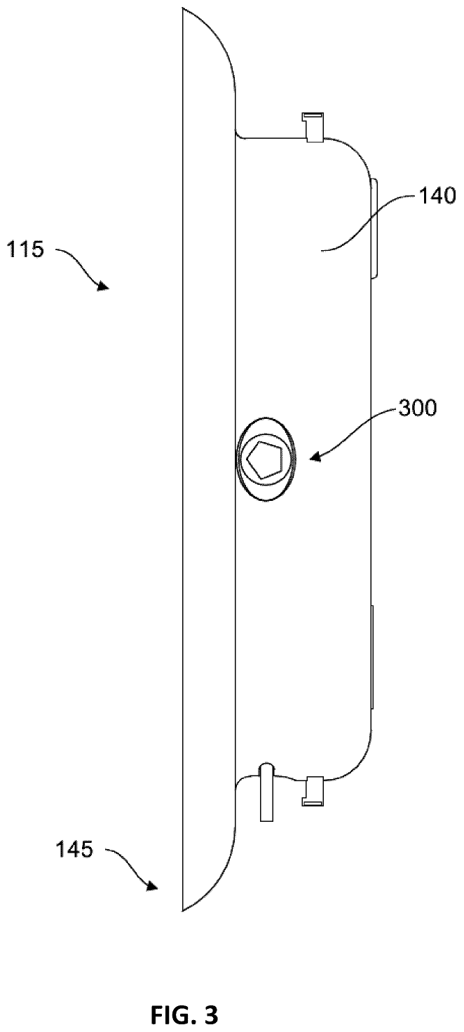

FIG. 3 shows a side-perspective of an embodiment of kiosk 100 in which there is a mounting orifice 300 to facilitate connection to the stand 200. The kiosk 100 is preferably but optionally fitted with multiple potential connection points so as to facilitate different orientations of the tub 100 when the tub 100 is connected to the stand 200. In the embodiment depicted in FIG. 3, the tub 115 has two connection points to facilitate vertical orientation and horizontal orientation of tub 115. In other embodiments, the tub 115 has greater than two connection points. In still further embodiments, the tub 115 is circular with connection points fitted around the circumference of the tub 115.

In the embodiment depicted in FIG. 3, the mounting orifice 300 has a pentagonal shape to match a pentagonal tip of the stand 200 so as to facilitate connection to the stand 200 and prevent the kiosk 100 from rotating in place. In other embodiments, the mounting orifice 300 is rounded and/or threaded so as to permit rotation of the kiosk 100 atop the stand 200. In other embodiments, the stand 200 has a clamp which locks in the height of the device and prevents the device from sliding up or down. In other embodiments, the mounting orifice is adjustable so as to change the angle of orientation of the tub 115 relative to the ground and thus relative to the subject to be photographed. The change in orientation of the tub 115 affects the angle of photograph. The lens 105 is perpendicular to the ground in some embodiments, is angled downward toward the ground is some embodiments, and is angled upward away from the ground is some embodiments. In other embodiments, the angle of the screen 110 and/or tub 115 is angled differently than the camera lens 105. For instance, in some embodiments, the screen 110 is angled downward while the camera lens 105 is angled straight or perpendicular to the ground.

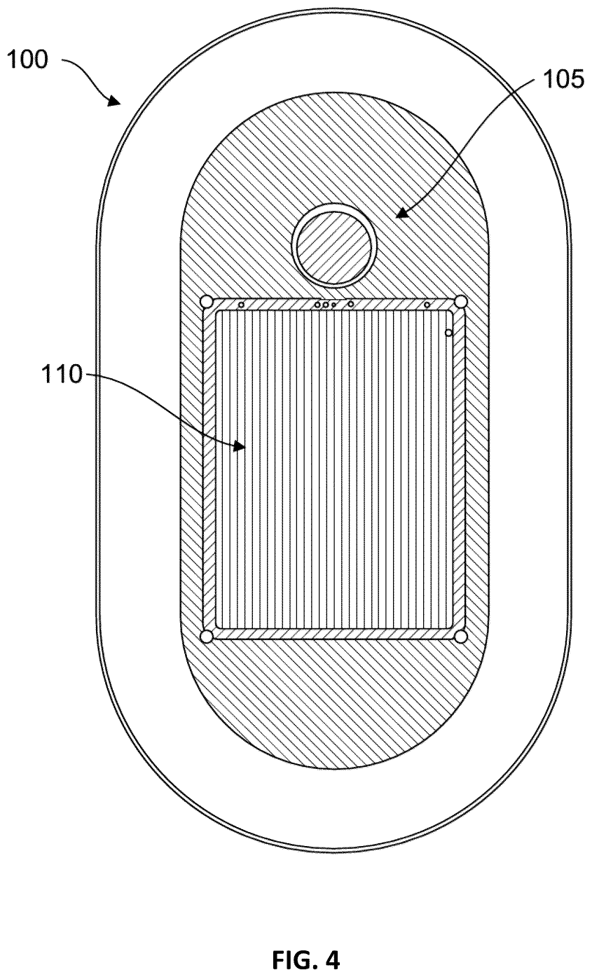

FIG. 4 depicts a vertical orientation of the kiosk 100 in which the lens orifice 135 is oriented above the screen 110. In other embodiments, the lens orifice 135 may be located below, to the side, or diagonally across from the lens 105. In the embodiment shown in FIG. 4, the tub 115 is oriented vertically with the mounting orifice 300 on the bottom of the tub 115 and the stand 200 below the tub 115.

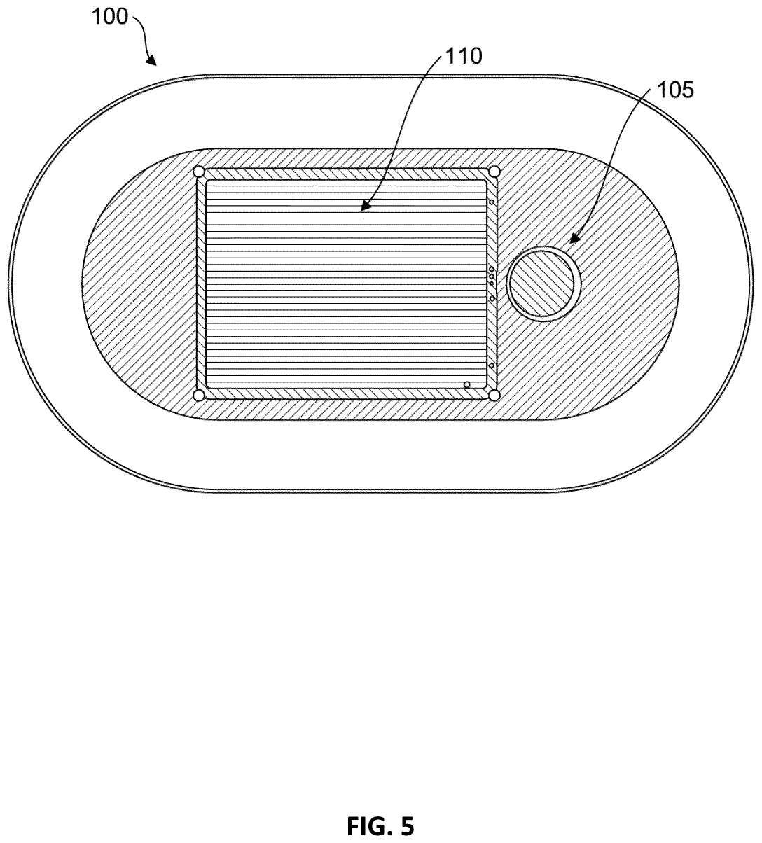

FIG. 5 depicts a horizontal orientation of the kiosk 100 in which the lens orifice 135 housing the lens 105 is oriented to the right of the screen 110. In other embodiments, the lens orifice 135 and lens 105 may be located below, to the side, or diagonally across from the lens 105.

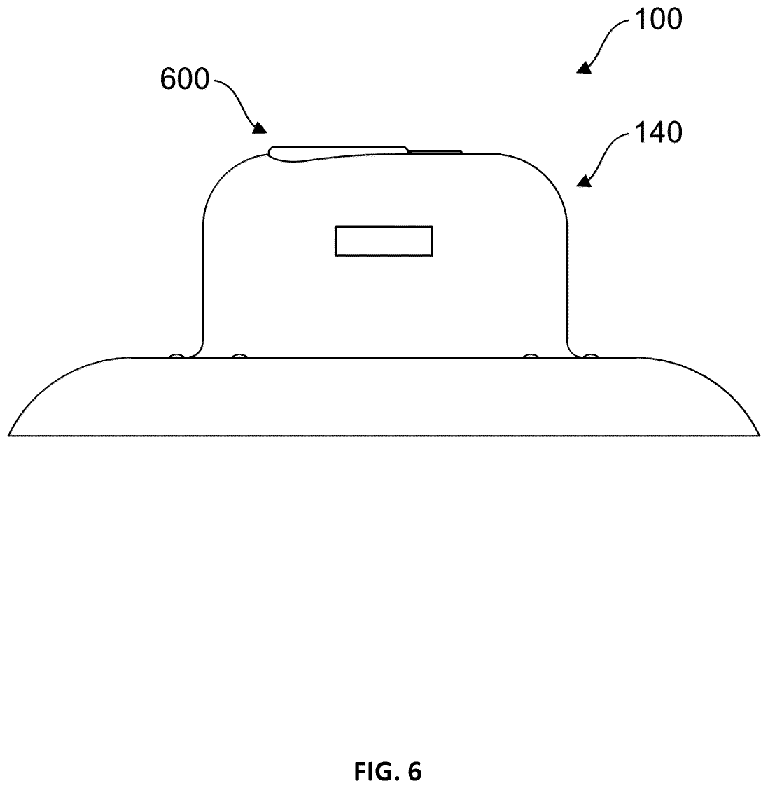

FIGS. 6 through 9 depict different perspectives of an embodiment of the kiosk 100.

FIG. 6 shows a top-side perspective view of kiosk 100 according to one embodiment. FIG. 6 depicts an embodiment which optionally but preferably includes a camera port door 600. The inclusion of camera port door 600 facilitates ease of access of the camera which contains lens 105. The inclusion of camera port door 600 allows the user to turn on the camera and to make necessary adjustments without having to disassemble the entire kiosk 100.

In the particular embodiment shown in FIG. 6, the material comprising camera port door 600 is relatively darker than the material comprising the tub 115 of the kiosk 100, which provides a color contrast and allows the camera port door 600 to be more easily seen. In some embodiments, the camera port door 600 comprises a snap-in configuration that allows it to snap in and snap out of the kiosk 100. In this particular embodiment, the camera port door 600 is located on the back surface of the kiosk 100 but in other embodiments it may be located elsewhere on the kiosk 100 such as on the side. In the embodiment shown in FIG. 6, the back surface of the camera port door 600 is flush with the tub 115. The camera port door 600 in FIG. 6 is thick enough to allow the user to easily grip the camera port door 600 in order to remove or insert the camera port door 600.

The camera port door 600 may optionally have a spring tension mechanism to secure the camera port door 600 to the hole in the kiosk 100. In some embodiments, the camera port door 600 has a screw that is used as an axis about which the camera port door 600 pivots. In the embodiment in which the camera port 600 has a screw, the camera port 600 rotates to open and then can be rotated back into the original position to close.

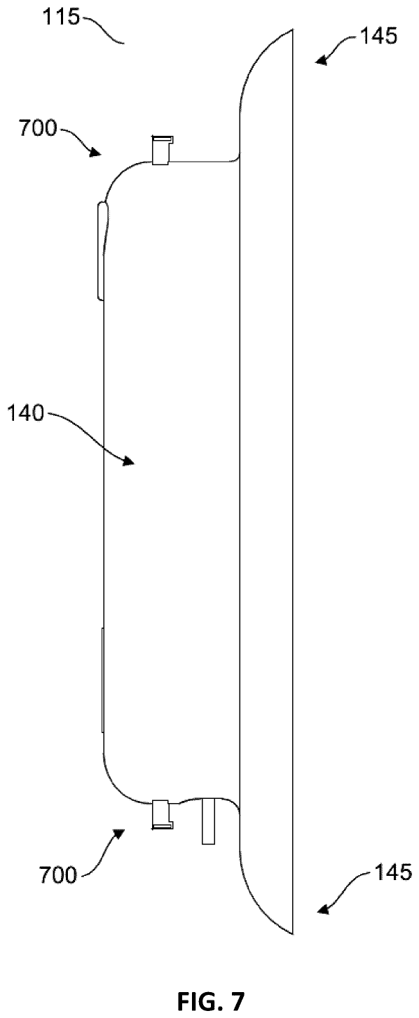

FIG. 7 shows a side view of kiosk 100. FIG. 7, shows a cord holder 700. In this embodiment, kiosk 100 has two cord holders 700 on the bottom and top of the kiosk 100. The cord holder 700 facilitates use or storage of a cord when a cord is necessary to power the system or device. The cord holder 700 holds the cord aside during assembly and disassembly of the kiosk 100. The cord holders 700 may also be used to wrap extra slack of cord when such extra slack exists such that the extra cord is not laying on the ground and causing a hazard of tripping or risk pulling down the kiosk 100 by accident or knocking the kiosk 100 over.

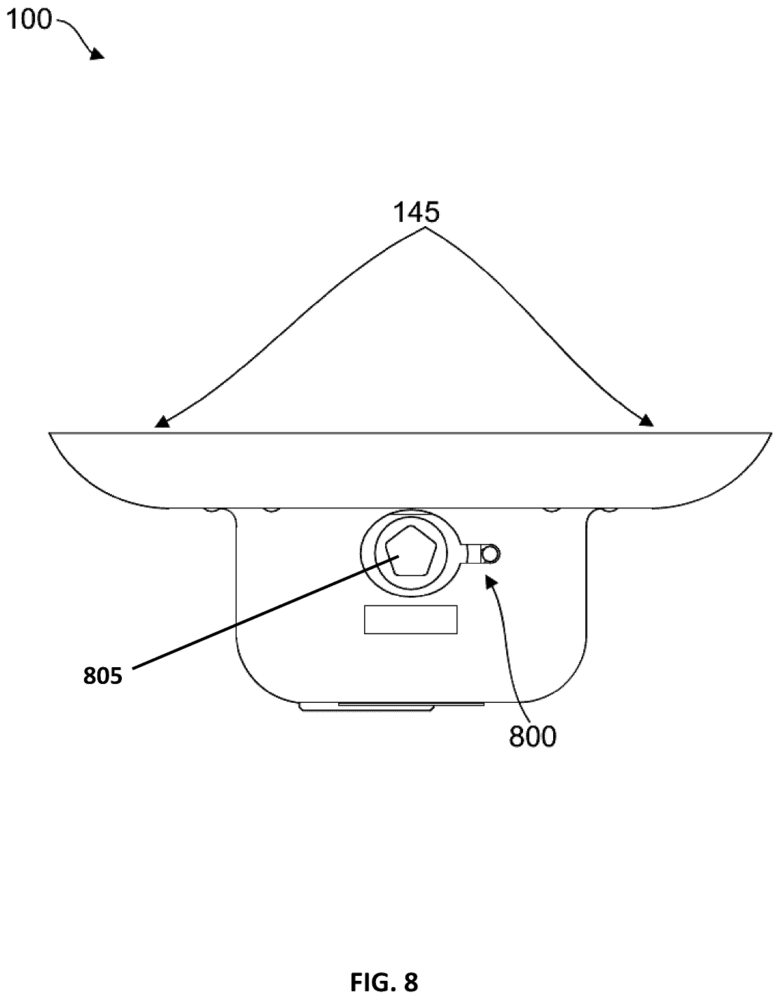

FIG. 8 shows an embodiment of kiosk 100 from the bottom-perspective when the kiosk 100 is in a vertical orientation. As shown in FIG. 800, the kiosk 100 includes a nook 800 which facilitates gripping any cord when a cord is necessary. The nook 800 holds the cord so that the cord does not tangle upon the stand 200 when the kiosk 100 is being attached to the stand 200. FIG. 8 also shows mounting orifice 805, used to mount or attach the kiosk 100 to stand 200. In some embodiments, the tub 115 simply sits atop stand 200.

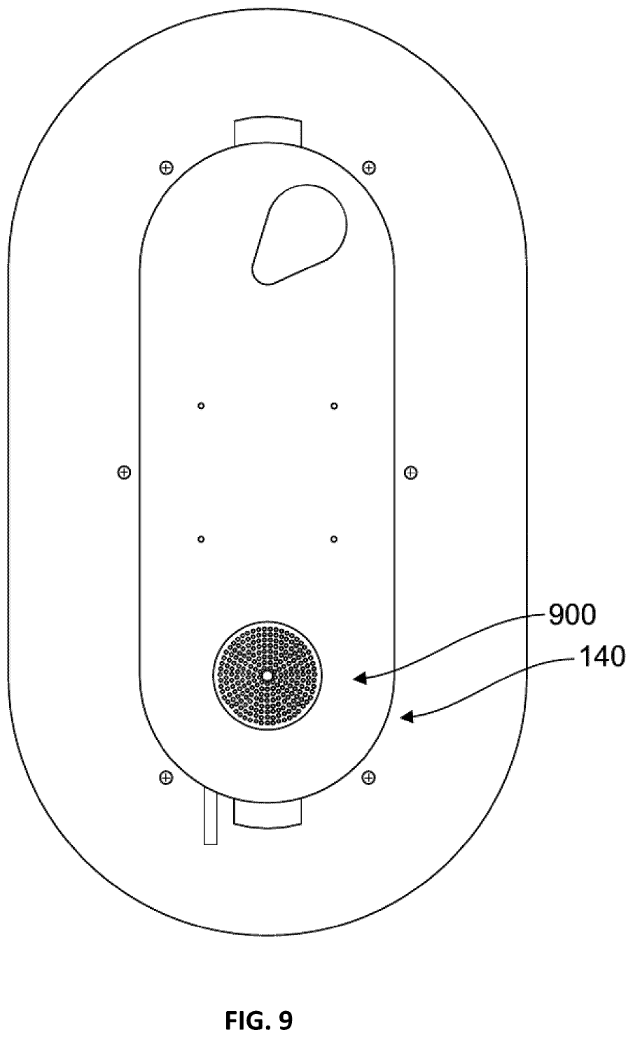

FIG. 9 shows a perspective view of the back surface of the kiosk 100. In FIG. 9, the kiosk 100 may have a fan aperture 900 which allows ventilation into the interior of the kiosk 100. The embodiment in FIG. 9 also depicts the housing bay 140. In some embodiments, the back surface of the kiosk 100 includes a housing bay 140 which protrudes from the rest of the surface on the back of the kiosk 140, which helps to give the kiosk 100 its tub shape in certain embodiments. In other embodiments, the housing bay 140 sits flush with the back surface of the kiosk 100. In still other embodiments, the back surface of the kiosk 100 forms a convex shape from the perspective of the back surface, including in orientations when the housing bay 140 is not discernible from the outer view of the kiosk 100.

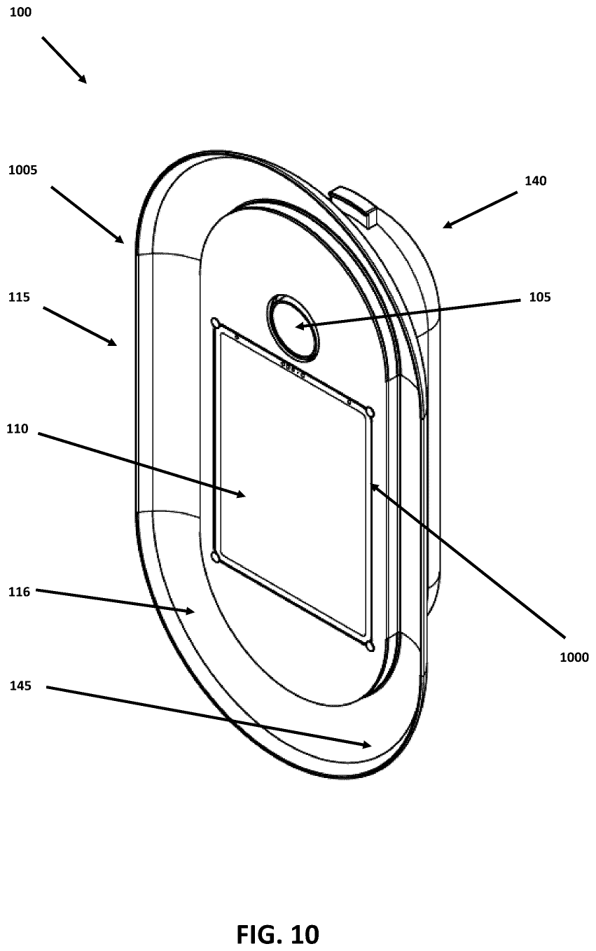

FIG. 10 shows a perspective view of the kiosk 100. The embodiment in FIG. 10 shows a border 1000 which surrounds the screen 110. The border 1000 may act as a frame and may also be used to provide structural support and stability of the screen 110. In the embodiment shown in FIG. 10 shows a rectangular screen but other embodiments may include screens which are not rectangular. In some embodiments, the screen 110 is circular or rounded at the edges. In still other embodiments, the screen is triangular or a prism shape. FIG. 10 further shows an optional snap line 1005. In some embodiments, the kiosk 100 is unibody apparatus. In other embodiments, the kiosk 100 has a tub 115 which may be broken into separate parts for storage and ease of handling. The separate parts of tub 115 can be placed together via screws, snap-in features, fasteners, et cetera.

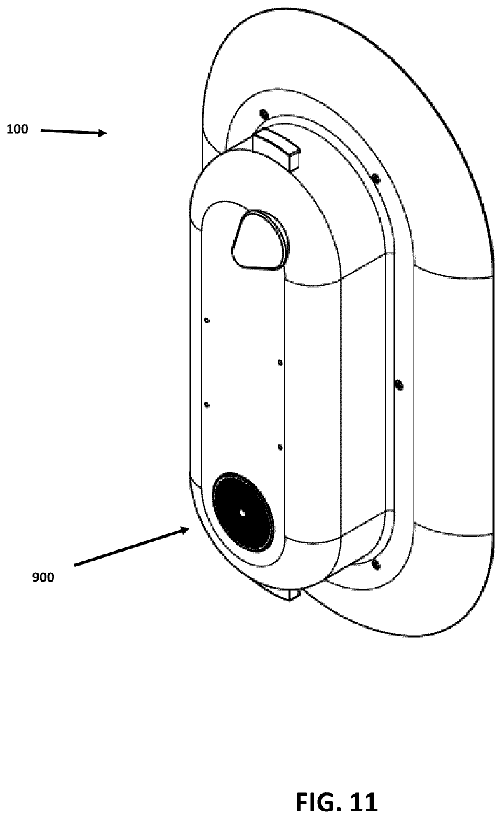

FIG. 11 shows a rear perspective view of kiosk 100. The fan aperture 900 may be ventilated with a grate or other opening. The fan aperture 900 may be circular but in other embodiments may be in other shapes, including rectangular shapes. The embodiment in FIG. 11 also shows the fan aperture 900 is in dark contrast from the body of the tub 115.

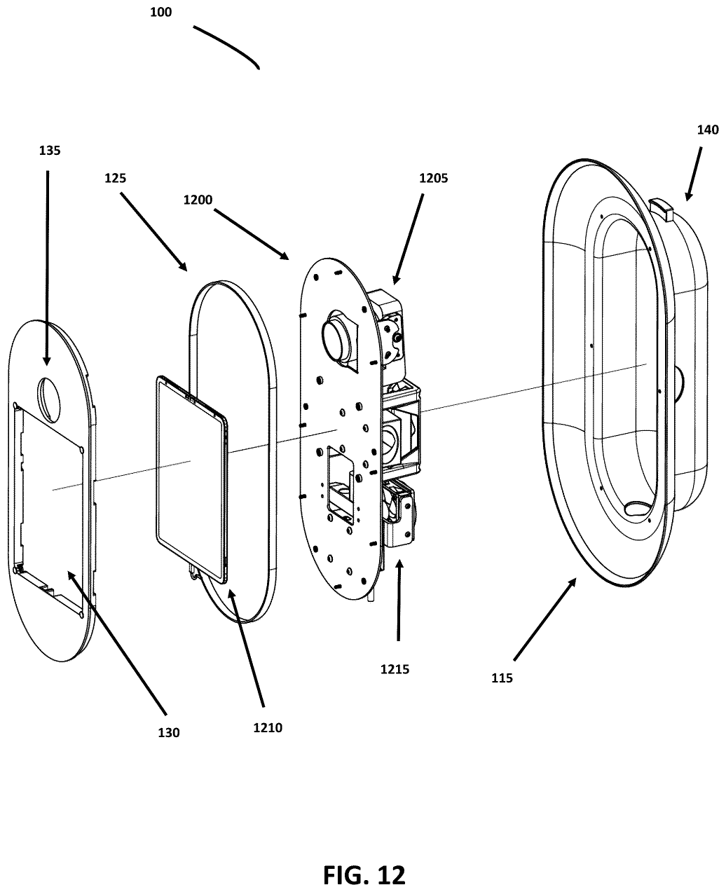

FIG. 12 shows a front-perspective exploded view of the kiosk 100. The kiosk 100 may include a mounting plate 1200 which may house a camera 1205. In some embodiments, the camera 1205 contains the camera lens 105 of the kiosk 100. The camera 1205 is housed on the plate 1200 such that the camera body of the camera 1205 aligns with the lens orifice 135. In some embodiments, the kiosk 100 includes a camera 1205 that is capable of standing alone, in other embodiments the kiosk 100 includes a camera that is integrated or a part of the kiosk 100 itself. In some embodiments, the kiosk 100 includes a screen device 1210. The screen device 1210 may be used to connect with the internet or platform. In some embodiments, the kiosk includes a wireless chip or a wired chip capable of networking. In some embodiments, the chip is on a printed circuit board. In some embodiments, the system includes a circuit board placed on a chip, which may include internet connection, Bluetooth, or Wi-fi. The screen device 1210 may be a ready-to-use tablet, including iPads, MicroSoft Surfaces, or other tablets or devices with screens. The screen device 1210 may be affixed to the front of the plate 1200. The camera 1205 may be mounted to the back of the plate 1200. The screen device 1210 may be mounted to the plate 1200 such that the screen 110 or a portion of the screen 110 aligns with the screen orifice 130 of the anterior side of the kiosk 100 and may be visible to a user standing in front of the kiosk 100. FIG. 12 also shows the tub 115, including the housing bay 140. The kiosk 100 may also have a fan 1215. The fan 1215 may be attached to a fan bracket. The fan 1215 may assist in regulating airflow. The fan 1215 may be configured to align with the fan aperture 900 of the kiosk 100. The fan 1215 may be programmed to regulate airflow or change rate based upon the temperature. In some embodiments, the portions of the aspects and devices of the kiosk 100 may be separately assembled as distinct parts and in other embodiments some or all of the aforementioned aspects of the kiosk 100 depicted in FIG. 12 may be configured as a singular unit.

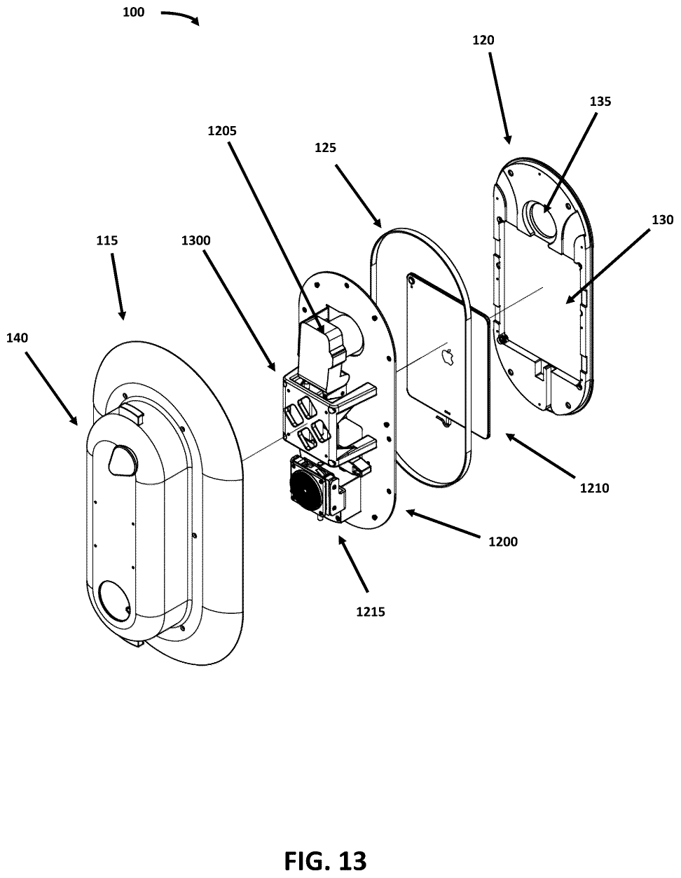

FIG. 13 shows a rear-perspective exploded view of an embodiment of kiosk 100. In FIG. 13, an embodiment is shown which has a circuit board 1300 which may be a printed circuit board or PCB. The circuit board 1300 can be used to integrate the separate systems and parts and may be used to network internal computer parts. The circuit board 1300 may be mounted to plate 1200. The circuit board 1300 may be programmed to relay commands and files between internal and/or external computer parts. For example, the circuit board 1300 may be used to integrate a system comprising the camera 1205, the screen device 1210, and/or the fan 1215.

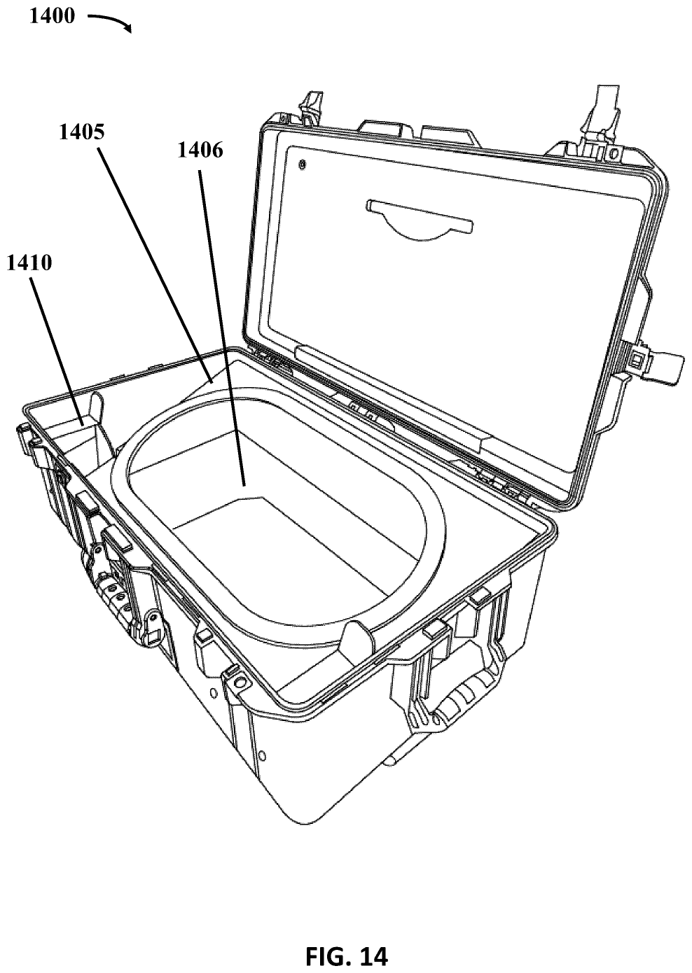

FIG. 14 shows a casing 1400 for storing a kiosk device, sometimes known as the Popcam. In some embodiments, the casing 1400 is a case which has a sloped portion 1405. The sloped portion 1405 may have an aperture 1406. The aperture 1406 may be a through-hole or an indentation designed to receive the tub 115. In some embodiments, the case additionally has a stand holder 1410 to receive stand 200.

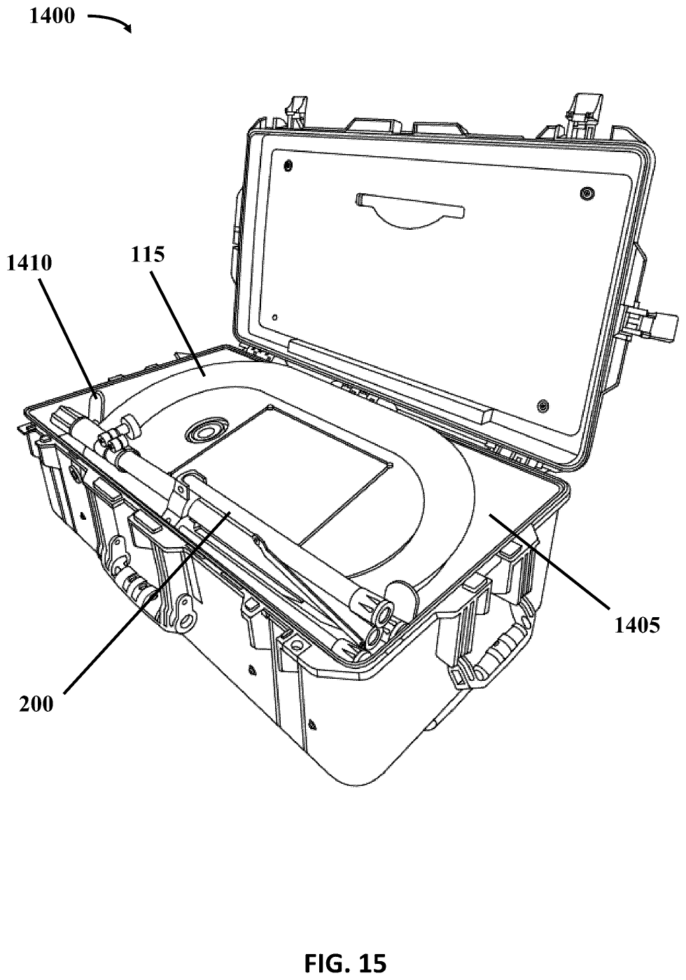

FIG. 15 shows the casing 1400 as a case in which tub 115 and stand 200 have been placed in the casing 1400. Placing the stand holder above the sloped portion facilitates the stand 200 being removed from the casing 1400 first, prior to removing the tub 115. Removing the stand 200 before removing the tub 115 facilitates proper setup of the camera kiosk because the tub 115 will set atop or attach to the stand 200. Thus, removing the stand 200 before removing the tub 115 will allow the tub 115 to be placed upon the stand 200 directly without having to place the tub 115 on the floor or elsewhere before retrieving the stand 200. This arrangement is especially useful when one person is setting up the device.

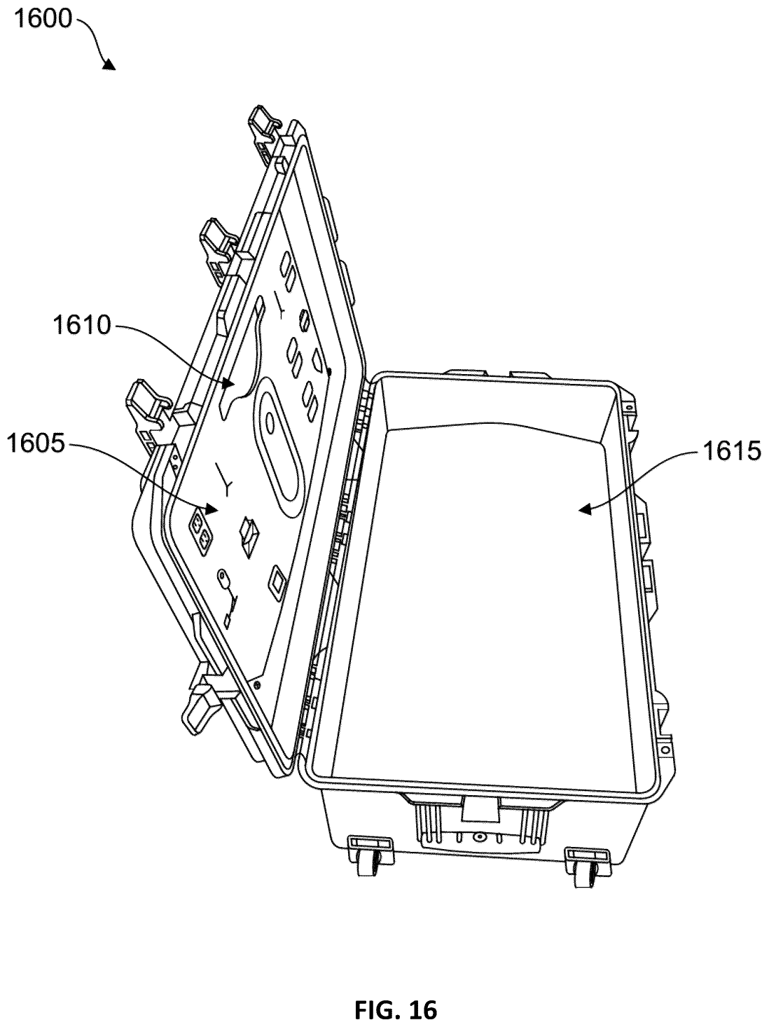

FIG. 16 shows an embodiment of a casing 1600 when the casing 1600 is laying in an open position. The casing 1600 may be configured to house the kiosk 100 and the stand 200. The casing 1600 may be rectangular in shape or may possess other shape configurations. The casing 1600 may have wheels. The casing 1600 may have an instruction panel 1605. The instruction panel 1605 stores and displays information as to how to setup and/or operate the kiosk 100 and/or the stand 200. The instruction panel 1605 may include specific sections as to the setup of the hardware and the operation of the apparatus. The instruction panel 1605 may include logos and brand imaging. The casing 1600 may also include a viewing panel 1610. The viewing panel 1610 may be used to display shipping information such as a posting. The casing 1600 may also include packaging material 1615. The packaging material 1615 may be in one singular unit or more than one unit. The packaging material 1615 may be colored such that certain information is communicated such as branding or orientation information concerning the device. The packaging material 1615 may also be configured to facilitate proper sequential loading and unloading of the device. For example, the packaging material 1615 may be wrapped or partitioned such that the stand 200 is placed properly so as not to damage the kiosk 100. The packaging material 1615 may also may be color coded so as to align with the portion of the device that each portion or the unit of packaging material 1615 is configured to protect. For example, the packaging material 1615 used to protect the kiosk 100 may be white if the kiosk 100 is also white or primarily white. The stand 200 may be protected by a packaging material 1615 that is the same color as the stand 200.

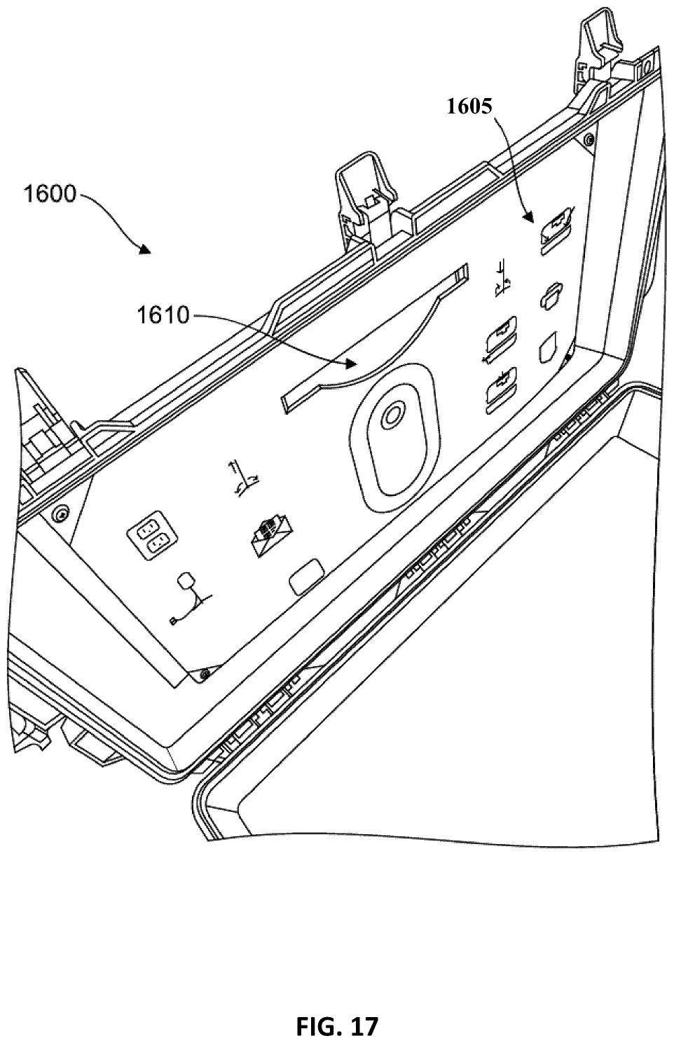

FIG. 17 shows a zoomed-in depiction of an example of the instruction panel 1605. In FIG. 17, the viewing panel includes a pocket or reservoir for holding the shipping label or sheet visible via viewing panel 1610.

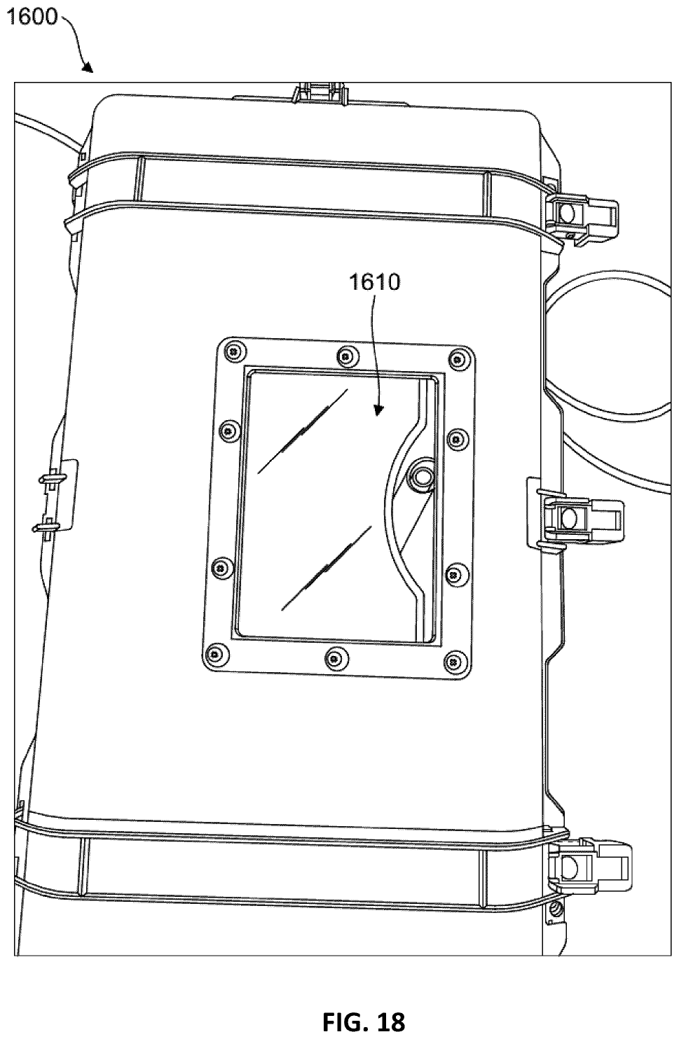

FIG. 18 shows an embodiment of the casing 1600. The exterior of the casing 1600 may include an information and may include the viewing panel 1610. The casing 1600 may include an “if lost” information mechanism such as a card or written material that facilitates returning the casing 1600 if it is lost or identifying the owner or user of the device and/or system.

The apparatus, casing 1600, and program may be used as a method of shipping a ready-to-use or easily configurable apparatus, pre-selecting a user experience or configuring a user experience, and/or facilitating shipping to a next user. The shipping information, label, or postage may be sent to or printed by the user and easily insertable in the viewing panel 1610.

Discussing the embodiments displayed in FIGS. 16-18, the viewing panel 1610 may be used to hold and display information such as a shipping label. The inside of the case 1600 optionally but preferably displays an instruction panel attached to the case. In some embodiments, the instruction panel may be removed or removable to be configured with different instructions. The case 1600 may have retention foam for safe storage during transport. The case 1600 may be equipped with soft material such as form-based foam. The form-based foam may have edged sides or bump-outs to prevent the foam from sliding or falling out of the its proper position within the case. The form-based foam may facilitate with proper sequential storage and removal of the device and components, in alignment with the instruction panel 1605. Additionally, the color of the foam may be used to guide users into proper storage of the device. For instance, certain portions of the foam may be white to denote that the white tub 115 is to be placed on the white foam. A portion of the foam may be yellow to denote placement of a yellow stand within the case. The stand 200 may be broken down into two or more parts and may be foldable over itself for ease of packaging, storage, and increased durability. Additionally, the case 1600 may be equipped with an “if lost” card to direct any finder or user to send the case 1600 and/or device back to the owner.

In some embodiments, the user will be directed to follow the sequence upon receipt of the case and device as to first open the case; remove the stand; set up the stand; remove the device; place the device on the stand; and plug it in. The user may then be directed to reverse this process upon conclusion of use of the device. The case is optionally but preferably equipped with a “FRAGILE” sticker to prompt delicate handling during shipping or use.

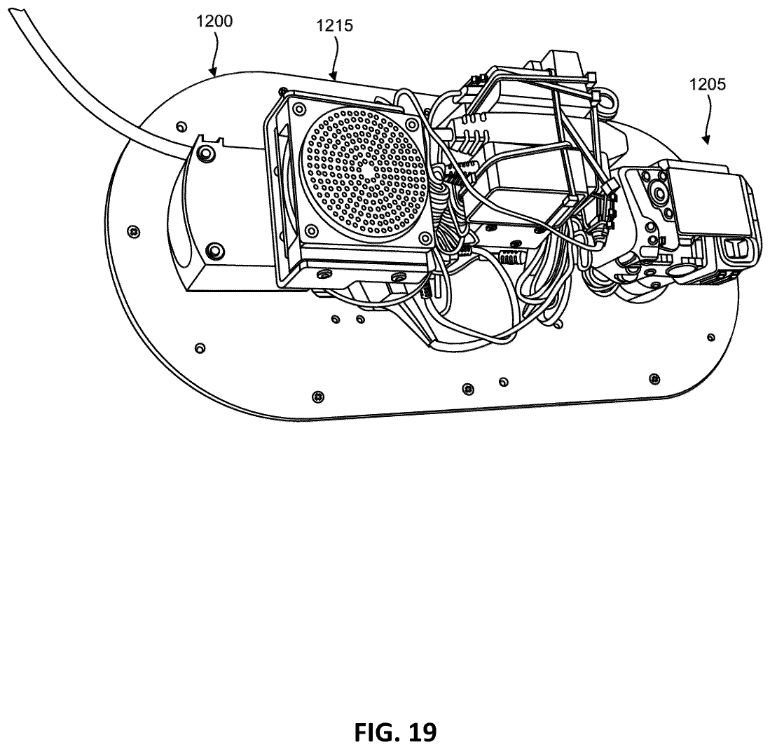

FIG. 19 shows a perspective rear view of a depiction of certain aspects of the apparatus. The camera 1205 may be mounted to the plate 1200 via a flange which may include screws for affixing the camera 1205 to the plate 1200.

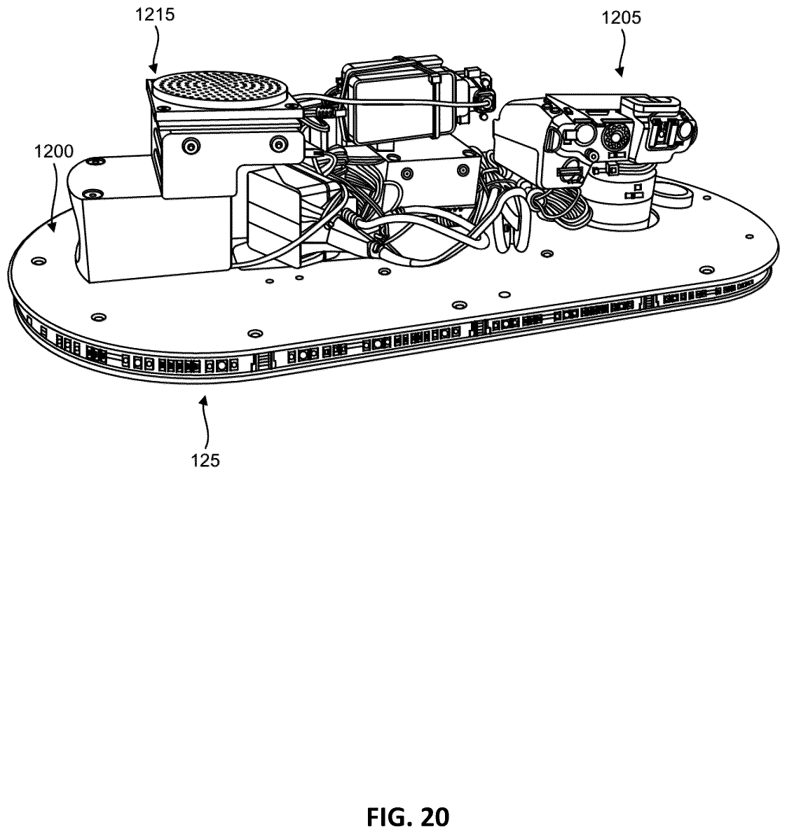

FIG. 20 is a perspective top view of the plate 1200 with certain aspects affixed according to one embodiment.

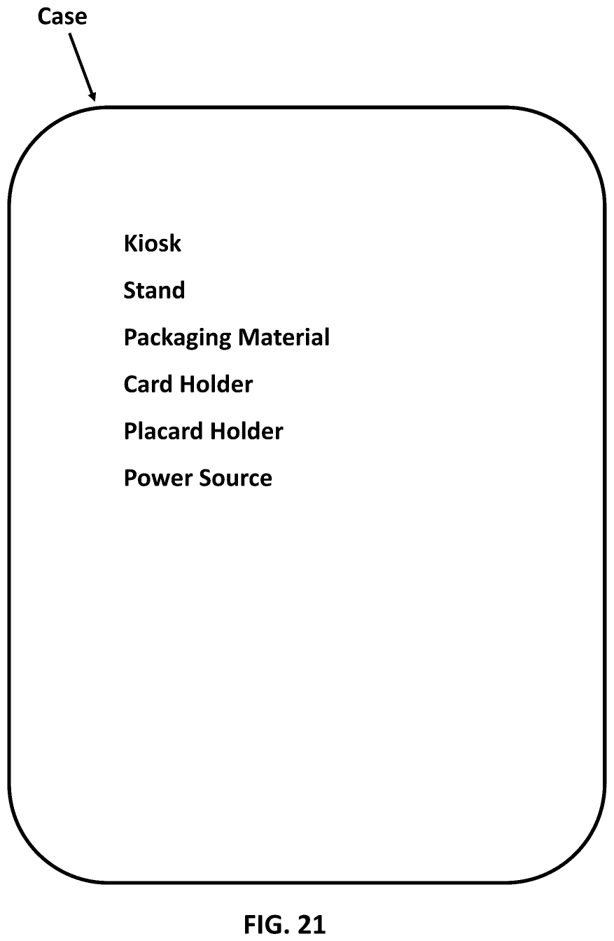

FIG. 21 shows a diagram of multiple aspects of the kiosk 100 and different features associated with the kiosk 100 as well as the casing 1600. The aspects shown in FIG. 21 comprise a battery or kit which may be used to as a kit to service patrons as part of a business model. Taken together, the battery or kit may be packaged and mailed to a patron for use in a setting in which photographs or recording are rendered.

FIG. 22 shows a zoomed in perspective view of a camera kiosk 100. In FIG. 22, there is an additional lightstrip 2200 which surrounds the lens orifice 135. The lightstrip 2200 acts as a light source which casts light towards the lens and may cast light at least partially radially perpendicular to the direction the lens 105 is facing across the inner array of arrows shown in FIG. 22.

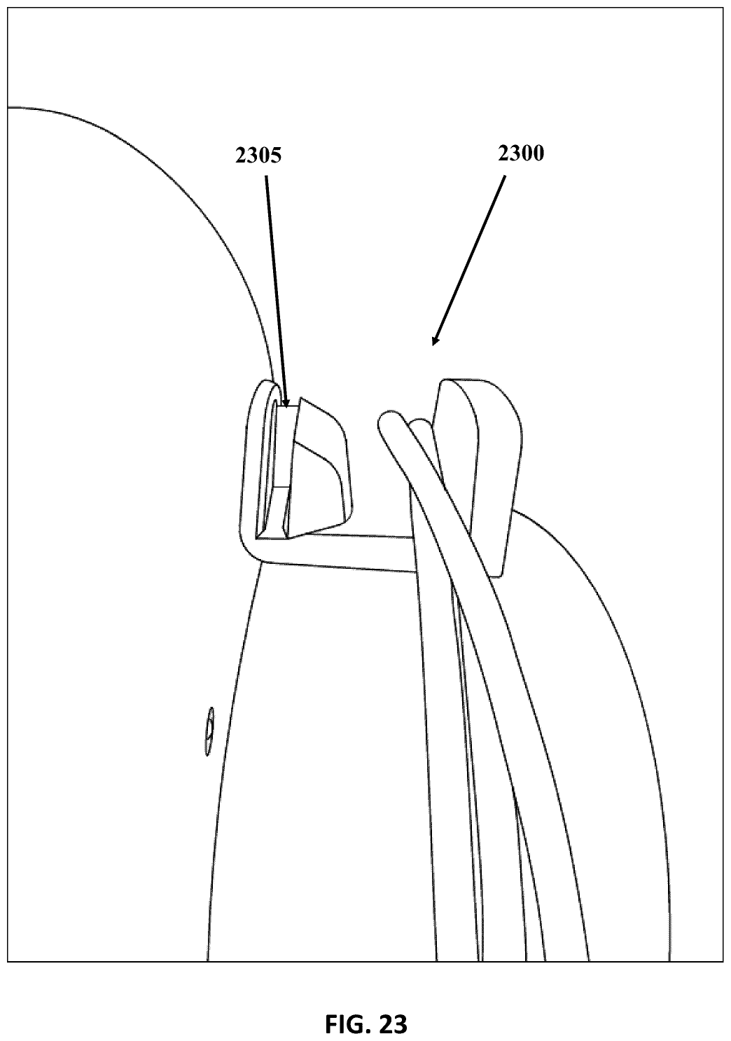

FIG. 23 shows a zoomed in perspective of a portion of a kiosk 100. In FIG. 23, the kiosk 100 has a cord holder 2300. The cord holder 2300 allows for a power cord to be wrapped and secured to the body of the kiosk 100 and unraveled easily when needed. The kiosk 100 shown in FIG. 23 also has a placard holder 2305. The placard holder 2305 allows an information-containing placard to be placed on the kiosk 100 so that a placard is visible above the kiosk 100. The placard can display valuable information such as a logo, trademark, a QR code, a symbol, prompts, instructions, or other information. Placards disclosed herein may be equipped with SHOOT codes or other QR-type information to facilitate the software upstart on a screen to facilitate the sequence for a photo shoot or video. Optionally but preferably the camera capture, lighting, user interface, and user experience flow are configurable either on-device or off device and are live-updatable via cellular network or via a SHOOT code. The SHOOT code is optionally but preferably a machine-readable code such as a QR or a barcode which may initiate the user interface or user experience and is programmed to be used by a participant and may be customized per user to optimize experience.

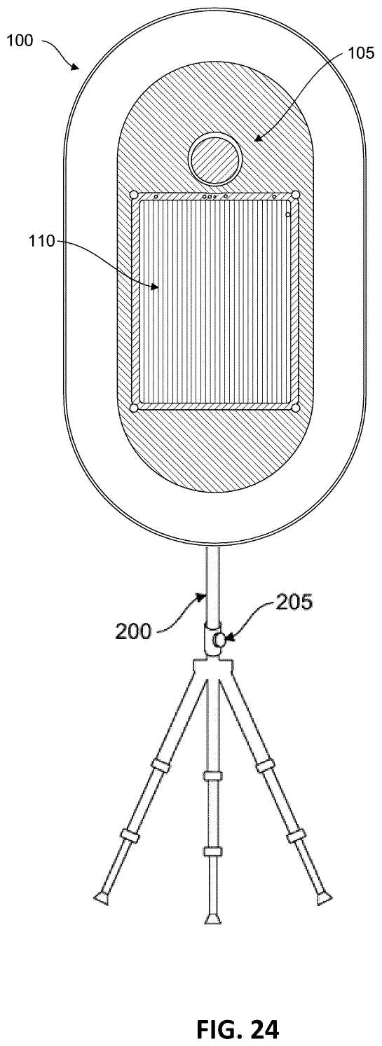

FIG. 24 shows a perspective view of an embodiment of camera kiosk 100 with stand 200, when the tub 115 is in the vertical orientation.

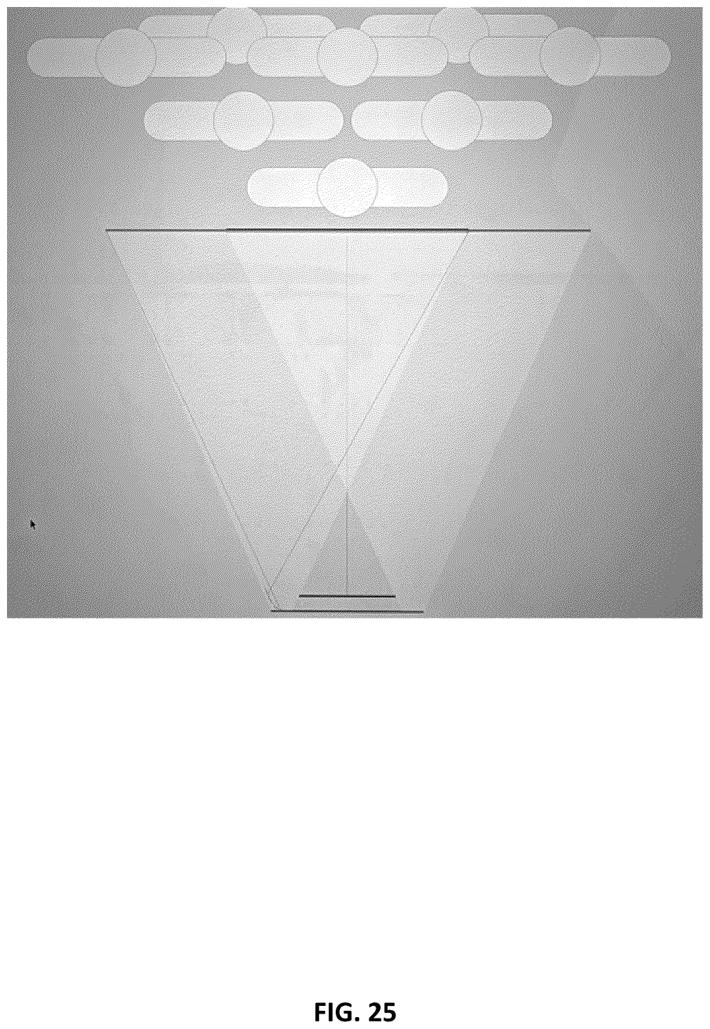

FIG. 25 shows an embodiment of the light cast by the camera kiosk 100. The light reflected by the tub 115 of the camera kiosk is angled such that the closer the subject is, the narrower the field of light shining or reflecting upon the subject(s). As the subjects are further away, the field of light shining or reflecting becomes wider. Thus, in the embodiment shown in FIG. 25, the field view of the kiosk has light shining more directly on subjects closer to the kiosk and has a wider array of light as the subject moves further away from the kiosk.

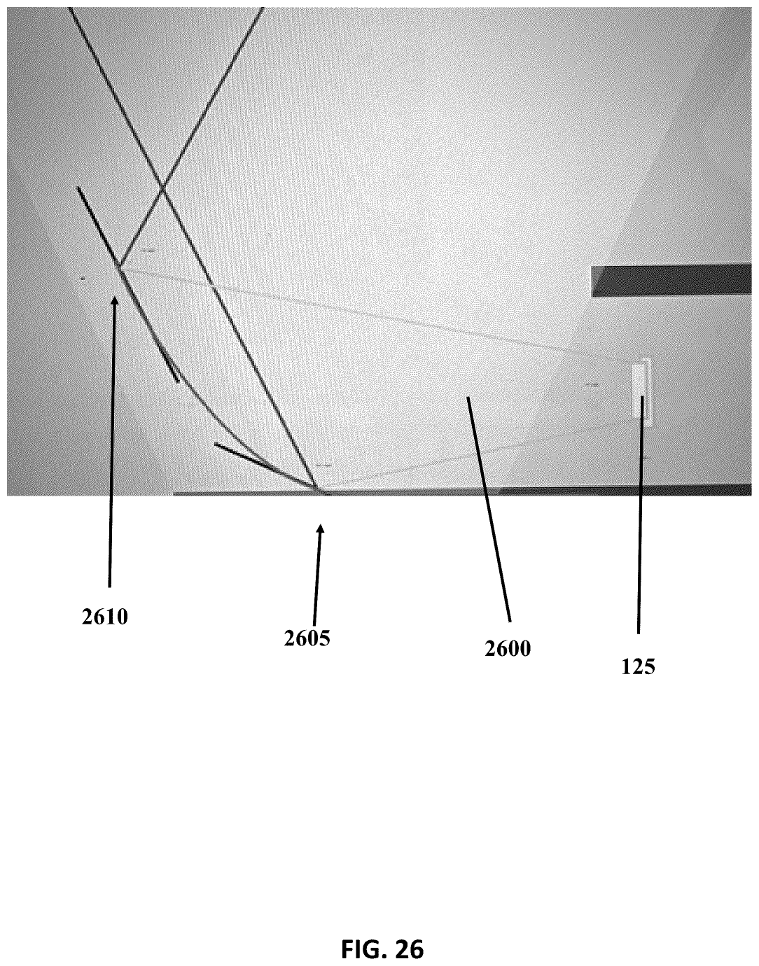

FIG. 26 shows a zoom-in of the reflection occurring according to the embodiment shown in FIG. 25. In FIG. 26, the angle of some of the reflection is visible. Light 2600 is cast from a light source such as lightstrip 125. As the light comes from the right-hand side of FIG. 26, the light 2600 is reflected off of the curve of tub 115. The edges of the light source, as directed from the light at lightstrip 125, are visible as the light moves from the right-hand side to the left-hand side of FIG. 26. The edges of the light strike different portions of the curve of tub 115 and are reflected at different angles. As the reflected light travels away from the tub 115, the reflect light intersects and continue to separate as the light continues to travel away from the tub 115. For instance, one edge of the light shining from the light source strikes the curve and is reflected as a first angle 2605. The other edge of the light shining from the light source strikes the curve and is reflected as a second angle 2610. In some embodiments and at some angles, the first angle is exactly or about 103 degrees. In other embodiments, the first angle is exactly or about 100 degrees, 90 degrees, or 80 degrees. In other embodiments, the first angle is exactly or about 105 degrees, 110 degrees, or 115 degrees. In certain embodiments the second angle is exactly or about 72 degrees. In other embodiments, the second angle is exactly or about 70 degrees, 65 degrees, or 60 degrees. In other embodiments, the second angle is exactly or about 75 degrees, 80 degrees, or 85 degrees. In some aspects, the first angle is greater or more obtuse than the second angle. In other embodiments or aspects, the second angle is greater or more obtuse than the first angle. The equal and opposite reflection is optionally but preferably occurring on the opposite side of the tub 115.

In some embodiments of the system, the program starts in idle mode, may then be activated by a SHOOT code, may then progress to session mode, may then communicate that the shoot has started, or may be pre-authenticated, may then direct to a user's profile. Subsequent to this process in certain embodiments, the program may use AI software to edit the photo, including background, teeth whitening, scrubbing, skin smoothing, brightness, et cetera. In some embodiments, the kiosk 100 prepares a composite photograph or video depicting a subject. In some aspects, the kiosk 100 is capable of printing an ID such as a photo ID from the photographs taken. In some aspects, kiosk 100 uploads subject matter to a computer server, cloud, or network attached storage. In some aspects, the kiosk 100 includes media storage capable of saving data such as photographs. The media storage includes a hard drive, removable media, SD cards, micro SD cards, CF cards, or a QXD card.

In some embodiments, the device may include an exterior tub configured to optimize structural integrity as well as photo settings such as light diffusion and brightness. The exterior tub may be colored white so as to reflect light without color cast. The tub is concave from a front viewer's perspective. The tub or portions of the exterior have a material finish that facilitates grip for ease of holding or adjustment. The material finish is also configured to facilitate light reflection to optimize photographic settings. The material finish additionally may have a “shine” that enhances the reflection properties of visible light.

In some embodiments, the device may have a foldable support structure. The foldable support structure can be configured to attached to the bottom surface of the kiosk devices, the back surface of the kiosk device, one of more sides of the kiosk device, or is able to pass through an orifice of the kiosk device. The support structure may be configured such that the more fragile or delicate or less dense portions are folded back upon the plane of the kiosk device itself or along a more dense, less delicate, or less fragile portion such that forces are redistributed through the more durable portion of the device and the less durable portions are reinforced. This may assist in facilitating structural integrity and durability during times such as while the device is in transport. Additionally, the device may be assembled without tools.

In some embodiments, the shape of the device is relatively longer on one axis. Such shaping, may help reduce the total height of a stand. Depending on the event or location, the height of the device may be configured to optimize photographic angles. For example, the total height of the device in some settings may be configured for normal-bodied adults which results in the stand configuration being approximately six feet tall. The shape of the housing device may also be oval so as to allow reflected light to illuminate a space of about 1 to about 6 feet away.

In some embodiments, the process may include a web application which may be accessible through a mobile device or a computer. The kiosk or device may begin in a storage facility. The platform may keep track of which device is assigned to which shoot, patron, or event. The person of contact may receive the device for the event or photo shoot. The platform may be used to create a shipping label for each patron. Optionally, the contact person may receive a label which includes shipping information to be placed in the casing. The contact person may receive the label via email, web, or may physically receive the label. The platform itself may be used to schedule a delivery or logistics pickup of the device and/or case. The user may set the device out for pickup to be sent to the next event or back to the owner. The kiosk or device may be checked at pickup for damage or the application may require the patron to submit a picture of the kiosk to confirm the status before sending to the next patron. The shipping of the kiosk or device may be directed by the status of the kiosk or device, such as directing back to warehouse. Camera kiosks or devices disclosed herein may be equipped with a location-tracker such as an Airtag for the purpose of tracking the location of the device, both when in use by a patron or from patron to patron. The kiosk optionally but preferably reports location, status updates, and other information back to the platform.

The platform may be used to manage the photos that are tagged to the users and may use software, GUI or AI to swap backdrops, to render touchups, or to modify the photographs. The platform may be used to create and manage groups for events including capture of group details; booking of the device for a shoot; inputting locations and dates; configuration of device details such as lighting, color, and editing details; viewing photos or videos; managing photos or videos; storing data; using the images, videos, or data stored to create products such as composites, digital media, and customize design details; and sync photos or headshots across platforms, including edits of photos while syncing.

Additionally, the screen device is optionally but preferably connected to the internet. In some embodiments, the device is connectable via cellular network.

The shape of the edges may also be curved so as to diffuse reflected light.

### LIST OF NUMBERED PARTS

Camera Kiosk 100
Camera Lens 105
Screen 110
Tub 115
Distal Portion 116
Faceplate 120
Lightstrip 125
Screen Orifice 130
Lens Orifice 135
Housing Bay 140
Lip 145
Curve 150
Stand 200
Clamp 205
Mounting Orifice 300
Camera Port 600
Cord Holder 700
Nook 800
Mounting Orifice 805
Fan Aperture 900
Border 1000
Snap line 1005
Plate 1200
Camera 1205
Screen Device 1210
Fan 1215
Circuit Board 1300
Casing 1400
Sloped Portion 1405
Aperture 1406
Stand Holder 1410
Casing 1600
Instruction Panel 1605
Viewing Panel 1610
Packaging Material 1615
Lightstrip 2200
Cord Holder 2300
Placard Holder 2305
Light 2600
First Angle 2605
Second Angle 2610

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the present disclosure has been illustrated and described in detail in the drawings and the foregoing description, the same is to be considered as illustrative and not restrictive in character, it being understood that only the preferred embodiment has been shown and described and that all changes and modifications that come within the spirit of the disclosure are desired to be protected. In addition, all references cited herein are indicative of the level of skill in the art and are hereby incorporated by reference in their entirety.

1. An apparatus for obtaining a photograph of a subject comprising:
a camera;
a touchscreen;
a light source;
a chassis whereupon said camera, said touchscreen, and said light source are mounted; and
wherein said chassis extends in the direction said camera is pointing.

2. The apparatus of claim 1, further comprising a printed circuit board wherein said printed circuit board is mounted on said chassis.

3. The apparatus of claim 1, wherein said chassis comprises one or more openings for a mount or stand.

4. The apparatus of claim 1, wherein said chassis comprises one or more openings for a mount or stand; and
wherein said one or more openings for a mount or stand comply with the Video Electronics Standards Association (VESA) standards.

5. The apparatus of claim 1,
wherein said chassis comprises one or more openings for a mount or stand;
wherein said one or more openings for a mount or stand comply with the Video Electronics Standards Association (VESA) standards; and
wherein said Video Electronics Standards Association (VESA) standards are VESA MIS-D, VESA MIS-E or VESA MIS-F standards.

6. The apparatus of claim 1, wherein said camera is a digital single lens reflex (DSLR) camera.

7. The apparatus of any one of claims 1, wherein said camera is a mirrorless camera.

8. The apparatus of claim 1, wherein said camera further comprises a lens.

9. The apparatus of claim 1, wherein said camera further comprises a lens; and
wherein said lens has a fixed focal length.

10. The apparatus of claim 1, wherein said camera further comprises a lens;
wherein said lens has a fixed focal length; and
wherein the fixed focal length of said lens is 12 mm, 24 mm, 35 mm, 40 mm, 50 mm, 80 mm, 85 mm, or 120 mm.

11. The apparatus of claim 1, wherein said camera further comprises a lens; and
wherein said lens does not have a fixed focal length.

12. The apparatus of claim 1, wherein said camera further comprises a lens;
wherein said lens has a focal length of 14-24 mm, 14-28 mm, 14-30 mm, 16-50 mm, 17-28 mm, 24-70 mm; 28-75 mm, or 70-200 mm.

13. The apparatus of claim 1, wherein said touchscreen comprises a light emitting diode (LED) screen, an organic light emitting diode (OLED) screen, or a liquid crystal display (LCD).

14. The apparatus of claim 1, wherein said touchscreen comprises a tablet computer which is synced to another platform.

15. The apparatus of claim 1, wherein said touchscreen comprises a tablet computer which is synced to another platform; and
wherein said tablet computer comprises an Apple iPad, Apple iPad Mini, or Apple ipad Pro.

16. The apparatus of claim 1, wherein said light source comprises one or more light emitting diodes (LEDs).

17. The apparatus of claim 1, wherein said light source comprises one or more light emitting diodes (LEDs); and
wherein the color temperature of said one or more light emitting diodes (LEDs) can be modified.

18. The apparatus of claim 1, wherein said light source comprises one or more light emitting diodes (LEDs);
wherein the color temperature of said one or more light emitting diodes (LEDs) can be modified; and
wherein said color temperature can be modified between 1,000 K and 10,000 K.

19. The apparatus of claim 1, further comprising a printed circuit board;
wherein said printed circuit board is mounted on said chassis; and
wherein said printed circuit board comprises a system on a chip.

20. The apparatus of claim 1, further comprising a printed circuit board;
wherein said printed circuit board is mounted on said chassis; and
wherein said printed circuit board comprises a networking chip.

21. The apparatus of claim 1, further comprising a printed circuit board wherein said printed circuit board is mounted on said chassis;
wherein said printed circuit board comprises a networking chip; and
wherein said networking chip is a wired networking chip or a wireless networking chip.

22. The apparatus of claim 1, further comprising a printed circuit board;
wherein said printed circuit board is mounted on said chassis;
wherein said printed circuit board comprises a networking chip;
wherein said networking chip is a wired networking chip; and
wherein said wired chip comprises ethernet.

23. The apparatus of claim 1, further comprising a printed circuit board;
wherein said printed circuit board is mounted on said chassis;
wherein said printed circuit board comprises a networking chip;
wherein said networking chip is a wireless networking chip; and
wherein said wireless chip comprises Bluetooth or Wi-Fi.

24. The apparatus of claim 1, wherein said apparatus further comprises a shipping container.

25. The apparatus of claim 1, wherein said apparatus further comprises a shipping container; and
wherein said shipping container is made from injection molded plastic.

26. The apparatus of claim 1, wherein said apparatus further comprises a shipping container; and
wherein said shipping container comprises a window for a shipping label.

27. A method for obtaining the photograph of a subject comprising the acts of:
obtaining the apparatus of any one prior claim;
applying power to said apparatus;
showing a QR code to the camera of said apparatus;
placing a subject in the field of view of said camera; and
capturing a photograph or video of said subject with said camera.

28. The method of claim 27, wherein the act of showing a QR code to the camera of said apparatus provides configuration of one or more settings of said apparatus.

29. The method of one of claims 27, further comprising shipping said apparatus to its next destination.

30. The method of one of claims 27, further comprising saving said photograph or video of said subject to a storage media.

31. The method of claim 27, further comprising saving said photograph or video of said subject to a storage media; and
wherein said storage media is a hard drive, removable media, SD card, Micro SD card, Compact Flash (CF) card, or QXD card.

32. The method of claim 27, further comprising the act of uploading said photograph or video of said subject to a computer server, a cloud, or network attached storage.

33. The method of claim 27, further comprising the act of processing said photograph or video of said subject to remove a background, smooth the skin of said subject, adjust the contrast, adjust the brightness, or add a background to said photograph.

34. The method of claim 27, further comprising the act of preparing a composite photograph or video comprising said photograph or video of said subject.

35. The method of claim 27, further comprising the act of printing an identification (ID) comprising said photograph or a portion of said photograph.
